(19) United States
(12) Patent Application Publication
(10) Pub. No.: US 2014/0118265 A1
(43) Pub. Date: May 1, 2014

(54) ELECTRONIC APPARATUS WITH PROXIMITY SENSING CAPABILITY AND PROXIMITY SENSING CONTROL METHOD THEREFOR

(71) Applicant: COMPAL ELECTRONICS, INC., Taipei City (TW)

(72) Inventors: Yi-Chen SUNG, Taipei City (TW); Ming-Che WENG, Taipei City (TW); Yu-Jen HUANG, Taipei City (TW)

(73) Assignee: COMPAL ELECTRONICS, INC., Taipei City (TW)

(21) Appl. No.: 13/662,720

(22) Filed: Oct. 29, 2012

(51) Int. Cl. G06F 3/041

(52) U.S. Cl. 345/173

(57) ABSTRACT

An electronic apparatus includes a display unit, a sensing unit and a processing unit. The processing unit includes a display module, a detecting module, a direction sensing and an activation module. The display module drives the display unit to display a processing bar and a present status indicator. The processing bar represents a range of possible statuses for a parameter of the electronic apparatus and the present status indicator represents a present status of the parameter. The detecting module utilizes the sensing unit determine if the detected object moves in a first direction more than a distance threshold in a pre-determined area. If so, the activation module readies the electronic apparatus for control of the parameter and for adjusting of the present status indicator.

### BACKGROUND

1. Technical Field

The present invention relates to an electronic apparatus. More particularly, the present invention relates to an electronic apparatus with proximity sensing capability, and to a proximity sensing control method for the electronic apparatus.

2. Description of Related Art

A video player can provide functions related to media playing, such as playing back digital video data from media such as optical discs (for example, DVD, VCD), as well as from files in various formats such as MPEG (Moving Picture Experts Group), AVI (audio video interleave), RealVideo®, and QuickTime. Furthermore, a video player may also provide VCR-like functions such as playing, pausing, stopping, rewinding, and forwarding, as well as some common additional functions including zooming/full screen, audio channel selection, subtitle selection, frame and capturing.

As for a control interface of a video player, a progress bar may be provided to indicate the progression of a video and for users to select which portion of a video that they want to see. In the prior art, when users want to select which portion of a video they want to see, an input device, such as a mouse, a keyboard, a touch screen, etc., must be used to perform such selection, which is inconvenient for users.

### SUMMARY

According to one embodiment of this invention, an electronic apparatus is provided, in which sensing results are used to adjust a parameter of the electronic apparatus. The electronic apparatus includes a display unit, a sensing unit and a processing unit. The processing unit is electrically connected to the display unit and the sensing unit. The processing unit includes a display module, a detecting module, and an activation module. The display module drives the display unit to display a processing bar and a present status indicator on the processing bar. The processing bar represents a range of possible statuses for the parameter of the electronic apparatus and the present status indicator represents a present status of the parameter of the electronic apparatus. The detecting module utilizes the sensing unit to determine if an object moves in a first direction more than a distance threshold in a pre-determined area. If the detected object moves in the first direction more than the distance threshold, the activation module activates the electronic apparatus to ready for subsequent control of the parameter of the electronic apparatus and also for adjusting the present status indicator relative to the processing bar.

According to another embodiment of this invention, a proximity sensing control method for an electronic apparatus is provided to adjust a parameter of the electronic apparatus according to sensing results. In the proximity sensing control method, a processing bar is displayed, and a present status indicator is displayed on the processing bar. The processing bar represents a range of possible statuses for a parameter of the electronic apparatus and the present status indicator represents a present status of the parameter of the electronic apparatus. Detection is performed to determine if an object is in a pre-determined area. When the object is in the pre-determined area, a determination is made as to whether the detected object moves in a first direction more than a distance threshold is sensed, If the detected object moves in the first direction more than the distance threshold, the electronic apparatus is activated to ready for subsequent control of the parameter of the electronic apparatus and for adjusting the present status indicator relative to the processing bar.

The present invention can achieve many advantages. A user can move his/her body to adjust the present status of an electronic apparatus without using an input device. In other words, the present invention provides convenience for users,

These and other features, aspects, and advantages of the present invention will become better understood with reference to the following description and appended claims. It is to be understood that both the foregoing general description and the following detailed description are by examples, and are intended to provide further explanation of the invention as

### BRIEF DESCRIPTION OF THE DRAWINGS

The invention can be more fully understood by reading the following detailed description of the embodiments, with reference made to the accompanying drawings as follows:

FIG. 1 illustrates a block diagram of an electronic apparatus according to one embodiment of this invention;

FIG. 2 illustrates an example of a processing bar and a present status indicator;

FIG. 3 illustrates another example of the processing bar and the present status indicator;

FIG. 4 illustrates still another example of the processing bar and the present status indicator;

FIG. 5 illustrates a scenario to use the electronic apparatus 100 of the present invention; and

FIG. 6 is a flow diagram of a proximity sensing control method for an electronic apparatus according to one embodiment of this invention.

### DETAILED DESCRIPTION

Reference will now be made in detail to the present embodiments of the invention, examples of which are illustrated in the accompanying drawings. Wherever possible, the same reference numbers are used in the drawings and the description to refer to the same or like parts.

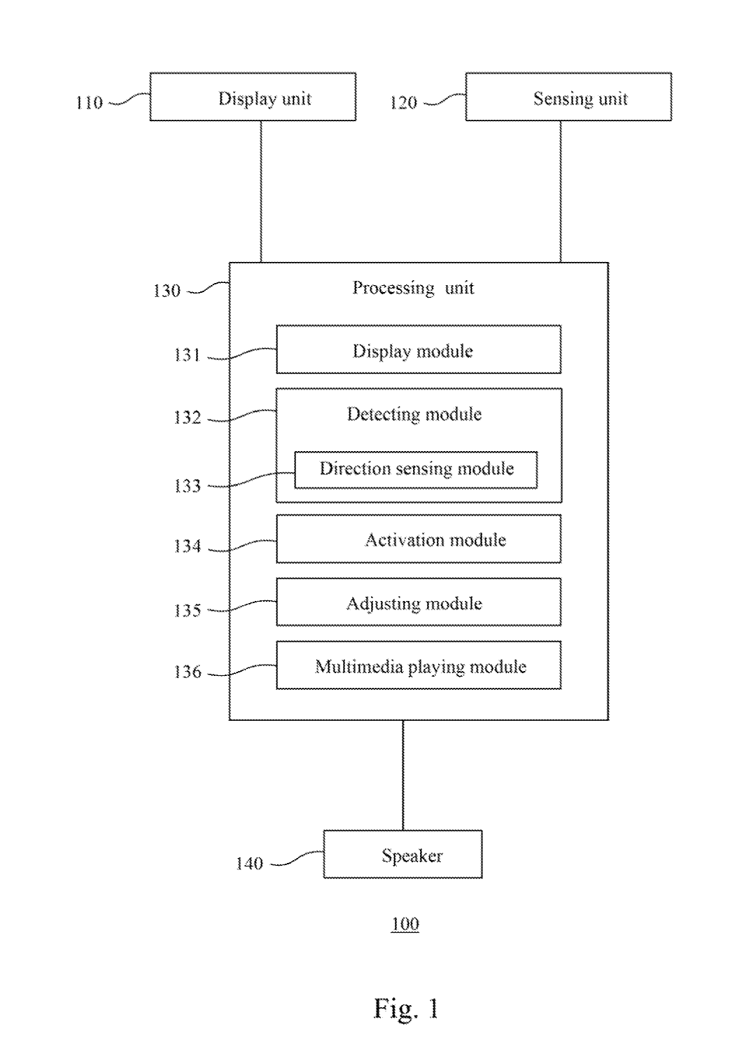

FIG. 1 illustrates a block diagram of an electronic apparatus according to one embodiment of this invention. The electronic apparatus has proximity sensing capability that is used to control a parameter of the electronic apparatus and to display a present status related to the parameter of the electronic apparatus according to sensing results.

The electronic apparatus 100 includes a display unit 110, a sensing unit 120 and a processing unit 130. The processing unit 130 is electrically connected to the display unit 110 and the sensing unit 120. The sensing unit 120 may be a light sensor, a near-field sensor, an Infrared (IR) sensor or any other type of sensing unit. The sensing unit 130 is used to sense an object. In one scenario of this invention, the sensing unit 130 may take a user's hand sensed by the sensing unit 130 as the object.

The processing unit 130 includes a display module 131, a detecting module 132, and an activation module 134. The display module 131 drives the display unit 110 to display a processing bar and a present status indicator displayed on the processing bar. The processing bar represents a range of possible statuses for the parameter of the electronic apparatus 100 controlled through the sensing capability of the electronic apparatus 100, and the present status indicator represents a present status of the parameter of the electronic apparatus controlled through the sensing capability of the electronic apparatus 100, such as a present processing percentage of a multimedia (video or audio) file played by a multimedia playing module 136 of the processing unit 130 of the electronic apparatus 100, a present volume generated by a speaker 140 of the electronic apparatus 100 or any other type of present status of the electronic apparatus 100.

The detecting module 132 utilizes the sensing unit 120 to determine if the object is in a pre-determined area. In some embodiments, the pre-determined area may be an area in front of the display unit 110 and a pre-determined distance from the same.

The detecting module 132 may further include a direction sensing module 133. When the object is in the pre-determined area, the direction sensing module 133 utilizes the sensing unit 120 to determine if the detected object moves in a first direction more than a distance threshold. In some embodiments, the direction substantially vertical to the direction along which the processing bar is displayed on the display unit 110 may be taken as the first direction.

If the detected object moves in the first direction more than the distance threshold, the activation module 134 activates the electronic apparatus 100 so that it is readied for subsequent control of the parameter of the electronic apparatus 100 and also for adjusting of the present status indicator relative to the processing bar. Subsequently, the parameter of the electronic apparatus 100 and the present status indicator relative to the processing bar can be adjusted. Therefore, a user can move his/her body to the pre-determined area for activating such adjustment without using an input device, such that convenience is provided to users. In some embodiments, if such adjustment is activated, some type of effect (such as a sound or a display) can be generated to provide notification to users. However, if the object is not in the pre-determined area or leave the pre-determined area, the detecting module 132 couldn't detect the object and the activation module 134 stops adjusting of the present status indicator of the electronic apparatus 100.

The processing unit 130 may further include an adjusting module 135 for performing such adjustment of the parameter of the electronic apparatus 100 and varying of the display of the present status indicator elative to the processing bar. As an example, when the detected object moves in a second direction, for example, a direction along which the processing bar is displayed on the display unit 110, the adjusting module 135 may adjust the parameter of the electronic apparatus 100 as well as the present status indicator relative to the processing bar according to a movement distance of the detected object in the second direction. That is, the adjusting module 135 may directly adjust the parameter of the electronic apparatus 100 (for example, by controlling the speaker 140) or indirectly adjust the parameter of the electronic apparatus 100 (for example, by controlling the multimedia playing module 136 to vary the processing percentage of a multimedia file). Furthermore, the adjusting module 135 may adjust the present status indicator relative to the processing bar by controlling the display module 131 to perform such control. The second direction is different from the first direction. Therefore, a user can move his/her body to adjust the parameter of the electronic apparatus 100 as well as the present status indicator relative to the processing bar without using an input device, such that convenience is provided to users.

In addition, when the direction sensing module 133 detects the detected object moves in a third direction, the activation module 134 stops activating the electronic apparatus 100 for subsequent control of the parameter of the electronic apparatus, and also stops activating the electronic apparatus 100 for adjusting of the present status indicator relative to the processing bar. Wherein, the third direction is substantially opposite to the first direction. Therefore, a user can stop adjustment without using an input device, such that convenience is provided to users.

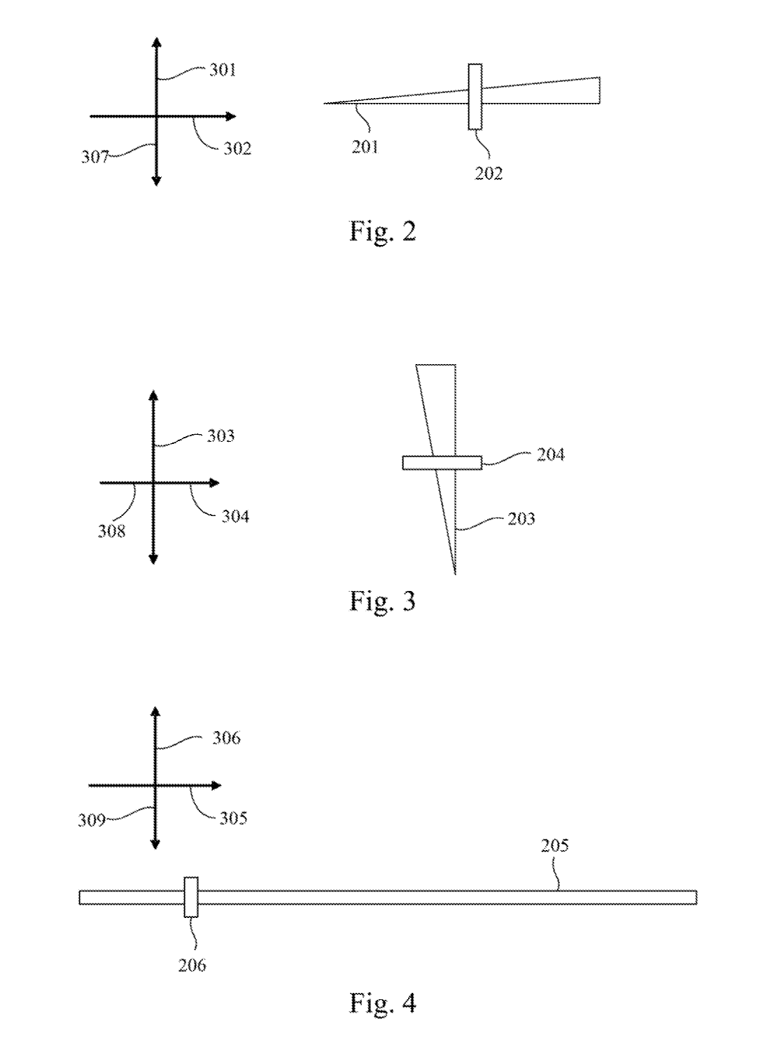

In some embodiments, the second direction is substantially perpendicular to the first direction. FIG. 2 illustrates an example of the processing bar and the present status indicator. The present status indicator 202 may represent a present status of the electronic apparatus 100, depending on its location relative to the processing bar 201. As an example, the present status indicator 202 may represent a volume of the speaker 140 of the electronic apparatus 100 or any other type of present status of the electronic apparatus 100.

In one embodiment of this invention, a user can move any part of his/her to body (such as his/her hand) in the pre-determined area, and then move in a first direction 301 vertical to the processing bar 201 (that is, the vertical direction) more than the distance threshold to activate adjustment. Subsequently, the user can move his/her body in the second direction 302 which coincides with the direction along which the processing bar 201 is displayed on the display unit 110, such that the parameter of the electronic apparatus 100 and the present status indicator 202 relative to the processing bar 201 can be adjusted in a manner corresponding to a movement distance of the user's body along the second direction 302. Then, the user can move his/her body in the third direction 307, which is substantially opposite to the first direction 301, to stop adjustment.

In some embodiments, the present status indicator 202 may move together as the user moves so that the user may better adjust the parameter of the electronic apparatus 100. In some embodiments, the first direction may be opposite to the direction 301, or the second direction may be opposite to the direction 302, which should not be limited in this invention.

FIG. 3 illustrates another example of the processing bar and the present status indicator. The present status indicator 204 may represent a present status of the electronic apparatus 100, depending on its location relative to the processing bar 203. As an example, the present status indicator 204 may represent a volume of the speaker 140 of the electronic apparatus 100 or any other type of present status of the electronic apparatus 100.

In one embodiment of this invention, a user can move any part of his/her body (such as his/her hand) in the pre-determined area, and then move in a first direction 304 vertical to the processing bar 203 (that is, the horizontal direction) more than the distance threshold to activate adjustment. Subsequently, the user can move his/her body in the second direction 303 which coincides with the direction along which the processing bar 203 is displayed on the display unit 110 such that the parameter of the electronic apparatus 100 and the present status indicator 204 relative to the processing bar 203 can be adjusted in a manner corresponding to a movement distance of the user's body along the second direction 303. Then, the user can move his/her body in the third direction 308, which is substantially opposite to the first direction 304, to stop adjustment.

In some embodiments, the present status indicator 204 may move together as the user moves so that the user may better adjust the parameter of the electronic apparatus 100. In some embodiments, the first direction may be opposite to the direction 304, or the second direction may be opposite to the direction 303, which should not be limited in this invention.

FIG. 4 illustrates still another example of the processing bar and the present status indicator. The present status indicator 206 may represent a present status of the electronic apparatus 100, depending on its location relative to the processing bar 205. As an example, the present status indicator 206 may represent a processing percentage of a multimedia (video or audio) file played by the electronic apparatus 100 or any other type of present status of the electronic apparatus 100.

In one embodiment of this invention, a user can move any part of his/her body (such as his/her hand) in the pre-determined area, and then move in a first direction 306 vertical to the processing bar 205 (that is, the vertical direction) more than the distance threshold to activate adjustment. Subsequently, the user can move his/her body in the second direction 305 which coincides with the direction along which the processing bar 205 is displayed on the display unit 110, such that the parameter of the electronic apparatus 100 and the present status indicator 202 relative to the processing bar 205 can be adjusted in a manner corresponding to a movement distance of the user's body along the second direction 305. Then, the user can move his/her body in the third direction 309, which is substantially opposite to the first direction 306, to stop adjustment.

In some embodiments, the present status indicator 206 may move together as the user moves so that the user may better adjust the parameter of the electronic apparatus 100. In some embodiments, the first direction may be opposite to the direction 306, or the second direction may be opposite to the direction 305, which should not be limited in this invention.

Referring to FIG. 1, in some embodiments, the present invention may be directed to only the proximity sensing capability of the electronic apparatus 100. As an example, in such embodiments, the present invention may comprise only the sensing unit 120 and the processing unit 130, and the multimedia playing module 136 may or may not be included in the configuration of the processing unit 130 of the present invention. In such embodiments, the present invention may be applied to any electronic apparatus to, using proximity sensing techniques as discussed above, vary a particular parameter of the same, and to control the electronic apparatus so that the present status indicator and the processing bar is displayed on a display of the electronic apparatus and the present status indicator is varied relative to the processing bar as the parameter of the electronic apparatus is controlled.

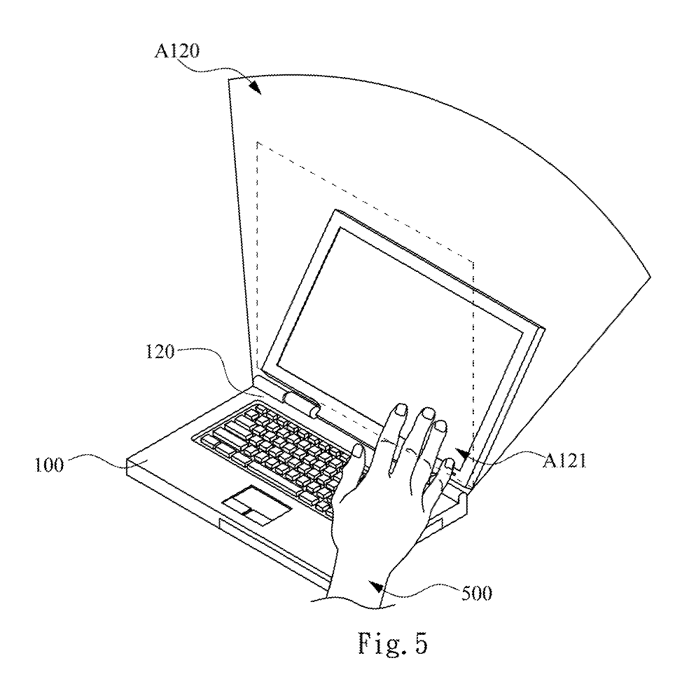

In some embodiments, the sensing unit has a sensing area, and the pre-determined area is at least a part of the sensing area. FIG. 5 illustrates a scenario to use the electronic apparatus 100 of the present invention. The sensing unit 120 has a sensing area A120. The pre-determined area A121 is a part of the sensing area A120. Hence, when the sensing unit 120 senses an object (for example, a user's hand 500), the detecting module 132 utilizes the sensing unit 120 to determine if the object (the user's hand 500) moves in a first direction more than a distance threshold in the pre-determined area A121 to be a factor for the activation of the activation module 134. When the detecting module 132 detects the object (the user's hand 500) is not in the pre-determined area A121, the activation module 134 stops activating the electronic apparatus 100 for subsequent control of the parameter of the electronic apparatus 100 and also stops activating for adjusting of the present status indicator relative to the processing bar.

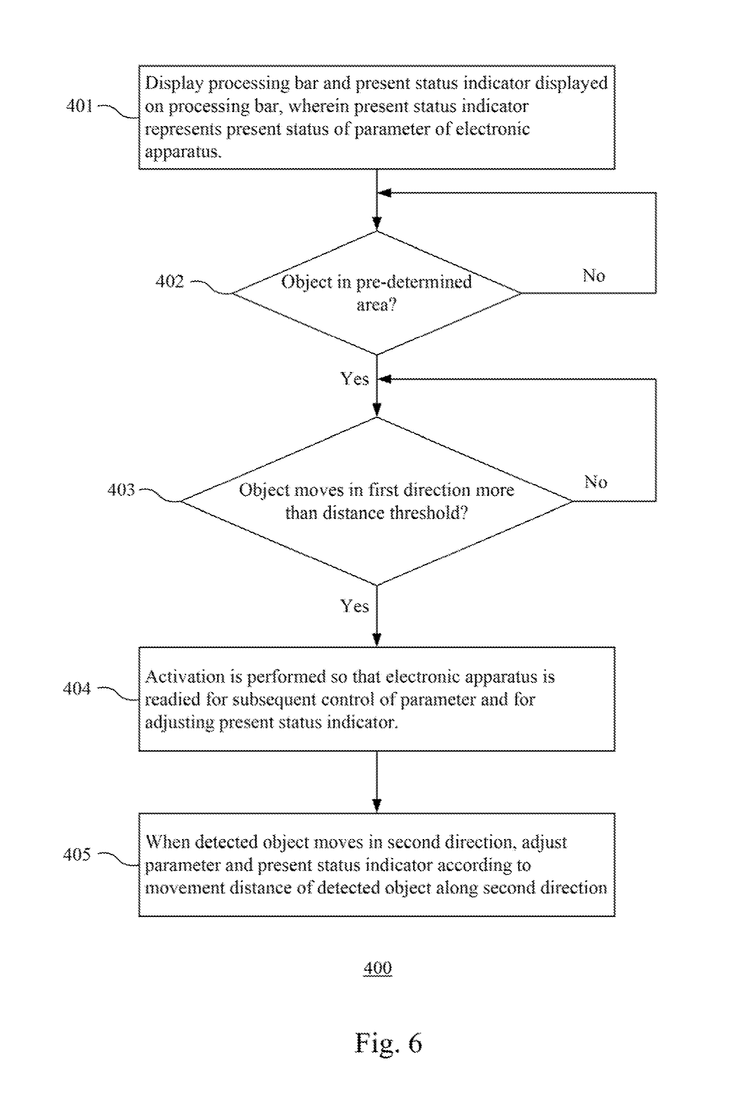

FIG. 6 is a flow diagram of a proximity sensing control method for an electronic apparatus according to one embodiment of this invention. In the proximity sensing control method, a present status of the electronic apparatus is activated for adjusting then actually adjusted according to sensing results. The proximity sensing control method can be implemented as a computer program product. The computer program product stores a computer program for an electrical apparatus. When an electrical apparatus loads the computer program stored in the computer program product, the electrical apparatus can execute the method. The computer program product may be stored in any suitable storage medium including non-volatile memory such as read only memory (ROM), programmable read only memory (PROM), erasable programmable read only memory (EPROM), and electrically erasable programmable read only memory (EEPROM) devices; volatile memory such as static random access memory (SRAM), dynamic random access memory (DRAM), and double data rate random access memory (DDR-RAM); optical storage devices such as compact disc read only memories (CD-ROMs) and digital versatile disc read only memories (DVD-ROMs); and magnetic storage devices such as hard disk drives (HDD) and floppy disk drives.

The routine 400 of the method begins at operation 401, where a processing bar is displayed and a present status indicator is displayed on the processing bar. The processing bar represents a range of possible statuses for the parameter of the electronic apparatus controlled through the sensing capability of the electronic apparatus, and the present status indicator represents a present status of the parameter of the electronic apparatus controlled through the sensing capability of the electronic apparatus, such as a present played percentage of a multimedia (video or audio) file played by the electronic apparatus, a present volume generated by a speaker of the electronic apparatus or any other type of present status of the electronic apparatus.

The routine 400 continues to operation 402, where a determination is made as to whether an object is in a pre-determined area. The determination of operation 402 may be made utilizing detection results of a light sensor, a near-field sensor, an IR sensor or any other sensing unit. The sensing unit has a sensing area, and the pre-determined area is at least a part of the sensing area.

If no object is detected in the pre-determined area, the routine 400 returns back to operation 402 for another determination.

If an object is detected in the pre-determined area, the routine 400 continues to operation 403, where a determination is made as to whether the detected object moves in a first direction more than a distance threshold. In some embodiments, the direction substantially vertical to the direction along which the processing bar is displayed may be taken as the first direction.

If the detected object does not move in the first direction more than the distance threshold, the routine 400 returns back to operation 403 for another determination. In some embodiments, if the detected object does not move in the first direction more than the distance threshold, the routine 400 returns back to operation 402 for another determination of whether an object is in the pre-determined area, such that it can be ensured that an object is present before performing detection of whether an object moves in the first direction.

If the detected object moves in the first direction more than the distance threshold, the routine 400 continues to operation 404, where activation is performed so that the electronic apparatus is readied for subsequent control of the parameter of the electronic apparatus and also for adjusting the present status indicator relative to the processing bar. Therefore, a user can move his/her body to the pre-determined area for activating adjustment without using an input device, such that convenience is provided to users. In some embodiments, if adjustment is activated, some type of effect (such as a sound or a display) can be generated to provide notification to users.

The routine 400 may further include operation 405. At operation 405, when the detected object moves in a second direction, the parameter of the electronic apparatus as well as the present status indicator relative to the processing bar may be adjusted according to a movement distance of the detected object in the second direction. The second direction is different from the first direction. For example, the second direction may be substantially perpendicular to the first direction. In one embodiment, the first direction may be vertical, and the second direction may be horizontal. In another embodiment, the first direction may be horizontal, and the second direction may be vertical. Therefore, a user can move his/her body to adjust the parameter of the electronic apparatus as well as the present status indicator relative to the processing bar without using an input device, such that convenience is provided to users.

In some embodiments of this invention, the routine 400 may further include the following operations: when the detected object moves in a third direction, the electronic apparatus stops being activated for subsequent control of the parameter of the electronic apparatus and also stops being activated for adjusting the present status indicator relative to the processing bar. Wherein, the third direction is substantially opposite to the first direction. Therefore, a user can stop adjustment without using an input device, such that convenience is provided to users.

In some embodiments of this invention, the routine 400 may further include the following operations: when the object is not in the pre-determined area, the electronic apparatus stops being activated for subsequent control of the parameter of the electronic apparatus and also stops being activated for adjusting the present status indicator relative to the processing bar.

The present invention can achieve many advantages. A user can move his/her body to adjust a parameter of an electronic apparatus and to adjust the to display of a present status indicator relative to a processing bar without using an input device. In other words, convenience is provided to users.

Although the present invention has been described in considerable detail with reference to certain embodiments thereof, other embodiments are possible. Therefore, the spirit and scope of the appended claims should not be limited to the description of the embodiments contained herein. It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims.

What is claimed is:

1. An electronic apparatus comprises:
a display unit;
sensing unit; and
a processing unit electrically connected to the display unit and the sensing unit, wherein the processing unit comprises:
a display module for driving the display unit to display a processing bar and a present status indicator on the processing bar, wherein the processing bar represents a range of possible statuses for a lit parameter of the electronic apparatus and the present status indicator represents a present status of the parameter of the electronic apparatus;
a detecting module for utilizing the sensing unit to determine if an object moves in a first direction more than a distance threshold in a pre-determined area; and
an activation module for activating the electronic apparatus to ready for subsequent control of the parameter of the electronic apparatus and also for adjusting of the present status indicator relative to the processing bar if the detected object moves in the first direction more than the distance threshold.

2. The electronic apparatus of claim 1, wherein the detecting module further comprises a direction sensing module for detecting the detected object moves in the first direction more than the distance threshold.

3. The electronic apparatus of claim 1, wherein the processing unit further comprises:
an adjusting module, wherein when the detected object moves in a second direction, which is along a direction the processing bar is displayed on the display unit, the adjusting module adjusts the parameter of the electronic apparatus and the present status indicator relative to the processing bar according to a movement distance of the detected object in the second direction, wherein the second direction is different from the first direction.

4. The electronic apparatus of claim 3, wherein the second direction is substantially perpendicular to the first direction.

5. The electronic apparatus of claim 3, wherein the first direction is vertical, and the second direction is horizontal.

6. The electronic apparatus of claim 1, wherein when the detecting module detects the detected object moves in a third direction, the activation module stops activating the electronic apparatus for subsequent control of the parameter of the electronic apparatus and also stops activating the electronic apparatus for adjusting of the present status indicator relative to the processing bar.

7. The electronic apparatus of claim 6, wherein the third direction is substantially opposite to the first direction.

8. The electronic apparatus of claim 1 further comprising:
a speaker electrically connected to the processing unit, wherein the present status indicator relative to the processing bar represents a present volume generated by the speaker.

9. The electronic apparatus of claim 1, wherein the processing unit further comprises:
a multimedia playing module for playing a multimedia file, wherein the present status indicator relative to the processing bar represents a present played percentage of the multimedia file played by the multimedia playing module.

10. The electronic apparatus of claim 1, wherein the sensing unit is a light sensor, a near-field sensor or an infrared (IR) sensor.

11. The electronic apparatus of claim 1, wherein the sensing unit has a sensing area, and the pre-determined area is at least a part of the sensing area.

12. The electronic apparatus of claim 11, wherein when the detecting module detects the object is not in the pre-determined area, the activation module stops activating the electronic apparatus for subsequent control of the parameter of the electronic apparatus and also stops activating for adjusting of the present status indicator relative to the processing bar.

13. A proximity sensing control method for an electronic apparatus comprising:
displaying a processing bar and a present status indicator on the processing bar, wherein the processing bar represents a range of possible statuses for a parameter of the electronic apparatus and the present status indicator represents a present status of the parameter of the electronic apparatus;
detecting if an object is in a pre-determined area;
when the object is in the pre-determined area, determining if the detected object moves in a first direction more than a distance threshold; and
if the detected object moves in the first direction more than the distance threshold, activating the electronic apparatus to ready for subsequent control of the parameter of the electronic apparatus and for adjusting the present status indicator relative to the processing bar.

14. The proximity sensing control method of claim 13 further comprising:
when the detected object moves in a second direction, adjusting the parameter of the electronic apparatus and the present status indicator relative to the processing bar according to a movement distance of the detected object along the second direction, wherein the second direction is different from the first direction.

15. The proximity sensing control method of claim 14, wherein the second direction is substantially perpendicular to the first direction.

16. The proximity sensing control method of claim 13 further comprising:
when the detected object moves in a third direction, the electronic apparatus stops being activated for subsequent control of the parameter of the electronic apparatus and also stops being activated for adjusting the present status indicator relative to the processing bar.

17. The proximity sensing control method of claim 16 further wherein the third direction is substantially opposite to the first direction.

18. The electronic apparatus of claim 13, wherein when the object is not in the pre-determined area, the electronic apparatus stops being activated for subsequent control of the parameter of the electronic apparatus and also stops being activated for adjusting the present status indicator relative to the processing bar.

19. The electronic apparatus of claim 13, wherein a sensing unit is utilized to detect if an object is in the pre-determined area, and the sensing unit has a sensing area, and the pre-determined area is at least a part of the sensing area.

20. The proximity sensing control method of claim 13, wherein a light sensor, a near-field sensor or an IR sensor is utilized to detect if an object is in the pre-determined area.
